(19) United States
(12) Patent Application Publication
(10) Pub. No.: US 2003/0179168 A1
(43) Pub. Date: Sep. 25, 2003

(54) VOLTAGE SIGNAL MODULATION SCHEME

(76) Inventors: SCOTT A. ROSENBERG, CAMPBELL, CA (US); EDMUND SANDBERG, MONTE SERENO, CA (US); SAMSON HUANG, CUPERTINO, CA (US)

Correspondence Address: ALOYSIUS T C AUYEUNG, BLAKELY SOKOLOFF TAYLOR & ZAFMAN, 12TH FLOOR, 12400 WILSHIRE BOULEVARD, LOS ANGELES, CA, 900251206

(21) Appl. No.: 08/993,104

(22) Filed: Dec. 18, 1997

(51) Int. Cl. G09G 3/36

(52) U.S. Cl. 345/87

(57) ABSTRACT

Briefly, in accordance with one embodiment of the invention, a circuit for modulating voltage signals includes: a first circuit configuration to substantially simultaneously and asynchronously drive respective positive and negative voltage signals onto respective voltage signal storage elements. The circuit includes a second circuit configuration to alternatively sample the respective voltage signal storage elements at a substantially predetermined rate.

Briefly, in accordance with another embodiment of the invention, a method of modulating a voltage signal locally includes the following. Respective positive and negative voltage signals are applied to respective voltage signal storage elements substantially simultaneously and asynchronously. The voltage signals of the respective voltage signal storage elements are then sampled alternately at a substantially predetermined rate.

Briefly, in accordance with one more embodiment, a method of modulating a voltage signal locally includes the following. Respective voltage signals are applied to respective voltage signal storage elements substantially simultaneously and asynchronously. The voltage signal storage elements are sampled at a substantially predetermined rate so as to locally produce the modulated voltage signal.

Briefly, in accordance with yet one more embodiment, a voltage signal modulation circuit includes a first circuit to substantially simultaneously and asynchronously drive respective voltage signals onto respective voltage signal storage elements and a second circuit to sample the respective voltage signal storage elements so as to locally produce a modulated voltage signal.

### BACKGROUND

1. Field

The present invention relates to a voltage signal modulation scheme, such as a voltage signal modulation scheme that may be employed to drive a display device, for example.

2. Background Information

Liquid crystal material, such as a nematic liquid crystal material, as may be employed in a liquid crystal display (LCD), for example, typically employs an alternating current (AC) voltage signal driven across its light modulating elements to maintain a substantially zero direct current (DC) bias. Without this, ionization and eventual degradation of the liquid crystal material may result. Typical approaches for the storage circuit and light modulating element have included placing a large storage capacitor under each liquid crystal cell with a voltage signal differential between this large capacitor and a top-plate being used to maintain an alternating differential voltage across the liquid crystal cell. One example of this is illustrated in FIG. 4 and described in greater detail hereinafter.

In order to maintain a substantially zero DC-bias, the differential voltage across the liquid crystal material is inverted. In order to invert the voltage across the liquid crystal cell, the charge stored in the underlying capacitor is inverted. At a 40-60 hertz rate typically employed for liquid crystal material, and with one to two million pixel elements, a significant bandwidth is desirable to accomplish this amount of signal modulation or variation. For example, (two million pixels) times (60 hertz) times (8 bits per pixel) provides on the order of 960 megabits per second. Furthermore, the difficulty of reliably reading voltage signal values off of the storage elements due to circuit noise and the precision desired per element for gray scale indicates that this refresh-inversion cycle be driven from additional, digital memory circuitry. This significant bandwidth implies that current silicon based liquid crystal display systems do not provide significant bandwidth, memory use or functionality advantages over conventional cathode ray tube (CRT) based display systems. A need, therefore, exists for a silicon-based system for modulating voltage signals that overcomes these disadvantages.

### SUMMARY

Briefly, in accordance with one embodiment of the invention, a circuit for modulating voltage signals includes: a first circuit configuration to substantially simultaneously and asynchronously drive respective positive and negative voltage signals onto respective voltage signal storage elements. The circuit includes a second circuit configuration to alternatively sample the respective voltage signal storage elements at a substantially predetermined rate.

Briefly, in accordance with another embodiment of the invention, a method of modulating a voltage signal locally includes the following. Respective positive and negative voltage signals are applied to respective voltage signal storage elements substantially simultaneously and asynchronously. The voltage signals of the respective voltage signal storage elements are then sampled alternately at a substantially predetermined rate.

Briefly, in accordance with one more embodiment, a method of modulating a voltage signal locally includes the following. Respective voltage signals are applied to respective voltage signal storage elements substantially simultaneously and asynchronously. The voltage signal storage elements are sampled at a substantially predetermined rate so as to locally produce the modulated voltage signal.

Briefly, in accordance with yet one more embodiment, a voltage signal modulation circuit includes a first circuit to substantially simultaneously and asynchronously drive respective voltage signals onto respective voltage signal storage elements and a second circuit to sample the respective voltage signal storage elements so as to locally produce a modulated voltage signal.

### BRIEF DESCRIPTION OF THE DRAWINGS

The subject matter regarded as the invention is particularly pointed out and distinctly claimed in the concluding portions of the specification. The invention, however, both as to organization and method of operation, together with objects, features and advantages thereof, may best be understood by reference to the following detailed description, when read with the accompanying drawings in which:

FIG. 1 is a circuit diagram illustrating an embodiment of a voltage signal storage circuit in accordance with the present invention;

FIG. 2 is a circuit diagram illustrating another embodiment of a voltage signal storage circuit in accordance with the present invention;

FIG. 3 is a circuit diagram illustrating yet another embodiment of a voltage signal storage circuit in accordance with the present invention;

FIGS. 4 and 7 are circuit diagrams illustrating embodiments of prior art active matrix pixel circuits;

FIG. 5 is a schematic diagram illustrating an embodiment of a light valve system that may employ an embodiment of a voltage signal storage circuit in accordance with the invention;

FIG. 6 is a schematic diagram illustrating an embodiment of a liquid crystal (LC) cell that may be used in conjunction with an embodiment of a voltage signal storage circuit in accordance with the invention.

### DETAILED DESCRIPTION

As previously described, it is typical for liquid crystal displays, including liquid crystal cells, such as nematic liquid crystal cells including nematic liquid crystal material, to employ an AC voltage signal driven across the liquid crystal display light modulating elements in order to maintain a substantially zero DC bias. Without this, ionization and eventual degradation of the liquid crystal material may result.

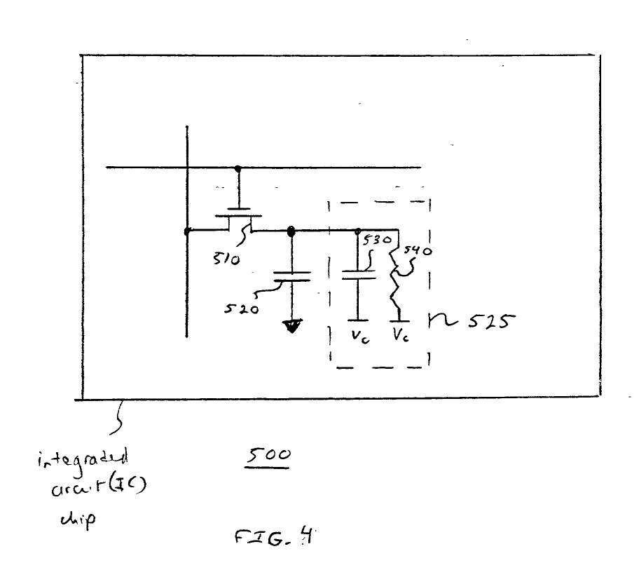

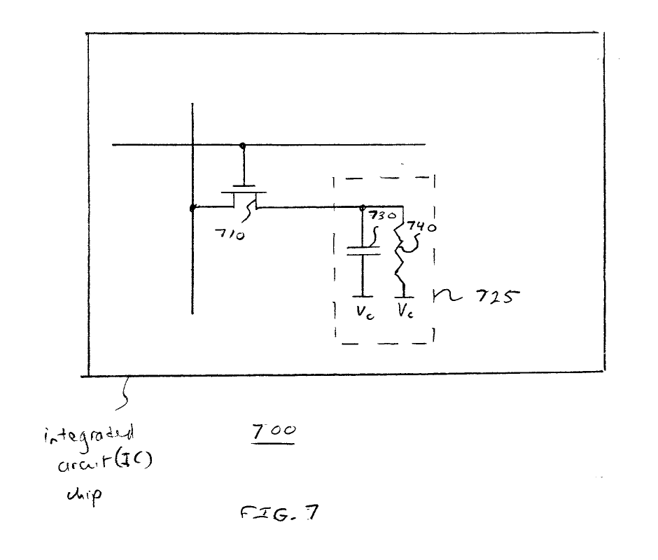

FIG. 4 is a circuit diagram illustrating an embodiment 500 of a prior art active matrix pixel circuit including a circuit for modulating a voltage signal to be applied to the active matrix pixel circuit. These circuits are illustrated as embodied on an integrated circuit (IC) chip, although the invention is not limited in scope in this respect. As illustrated, a transistor 510 is provided to address the particular pixel. For example, transistor 510 may be coupled to a circuit configuration for addressing the pixel, such as via random addressing. Likewise, a voltage to be applied to capacitor 520 is applied to the source of transistor 510. As illustrated in FIG. 4, capacitor 520 is coupled under or adjacent to active pixel matrix 525. Transistor 510 is employed to maintain an alternating differential voltage across the liquid crystal material of the cell by driving alternating inverted voltages onto capacitor 520. FIG. 7 is a circuit diagram illustrating an embodiment without a capacitor, such as 520, to improve the performance of the active matrix pixel circuit incorporating a liquid crystal cell.

As previously described, a disadvantage of this approach is the bandwidth to provide the desired AC voltage signal across the liquid crystal cell or material. More specifically, the voltage signal is continually inverted in order to provide the desired alternating voltage signal. In this embodiment, a voltage signal having an inverted polarity is applied to transistor 510 to replace the previous voltage signal applied. Therefore, as previously indicated, for a sufficient number of pixels, such as one to two million, and a reasonable frequency, such as 40 to 60 hertz, a significant bandwidth is difficult to achieve in digital circuitry without introducing greater expense and/or complexity.

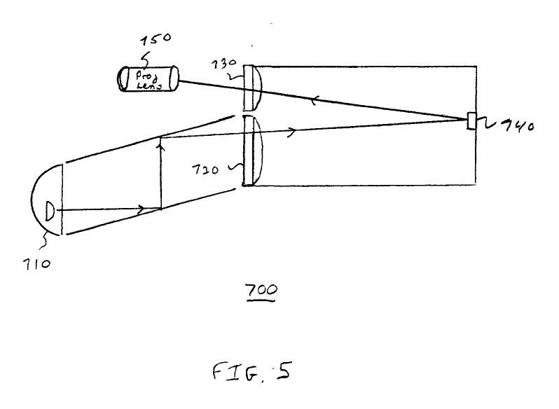

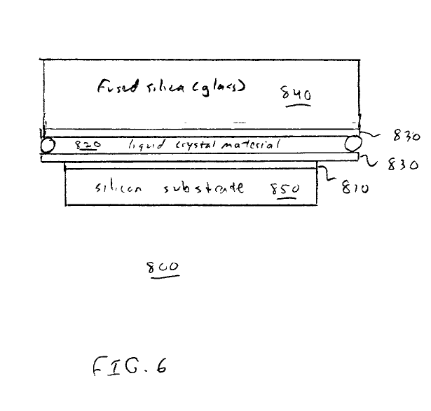

In one embodiment, although the invention is not restricted in scope in this respect, a voltage signal modulation circuit may be employed in conjunction with a light valve. For example, although, again, the invention is not limited in scope in this respect, a light valve may be implemented as illustrated in FIG. 5. For example, a lamp 700 may emit light, illustrated in FIG. 6 as light rays. These light rays travel along a path through a polarizer, such as polarizer 720. The polarized light impinges upon light valve 740 and is then reflected along another path so that the reflected light ray then passes through polarizer 730. Likewise, light valve 740 in this embodiment, depending upon the type of material and other aspects of the light valve, effectively rotates the polarization of the light that impinges upon it and is reflected. Therefore, depending upon the amount of rotation, only a portion of the light is transmitted through polarizer 730 and reaches projection lens 750. Of course, properties of the polarizers also affect the amount of light that reaches 750. A “valve” operation, therefore, is accomplished in the manner just described.

As illustrated by the simplified diagram in FIG. 6, the amount of rotation applied to the polarized light is controlled, at least in part, by applying a voltage across a liquid crystal cell. For example, as illustrated in FIG. 6, this liquid crystal cell material 820 is sandwiched between a metal plate 830 and a silicon substrate 850. In the embodiment illustrated, 810 comprises a dielectric coating. In this particular embodiment, silicon substrate 850 has been fabricated to include transistors and capacitors coupled to apply a differential voltage signal across the liquid crystal material 820 and affect the amount of rotation applied to the polarized light that impinges upon the liquid crystal cell and is reflected, as previously described. In this particular embodiment, although the invention is not limited in scope in this respect, where nematic liquid crystal cell material ZLI1560, available from Merck & Co., Inc., Whitehouse Station, N.J., is employed, the amount of rotation applied is affected by the magnitude of the voltage signal applied, as opposed to its polarity in this case. However, as previously described, it is desirable to apply an alternating, differential voltage across the liquid crystal cell material to reduce ionization and degradation. Therefore, by applying inverted voltage signals across the LC material and adjusting the magnitude of the voltage, the amount of reflected light to reach the projection lens may be adjusted in this embodiment.

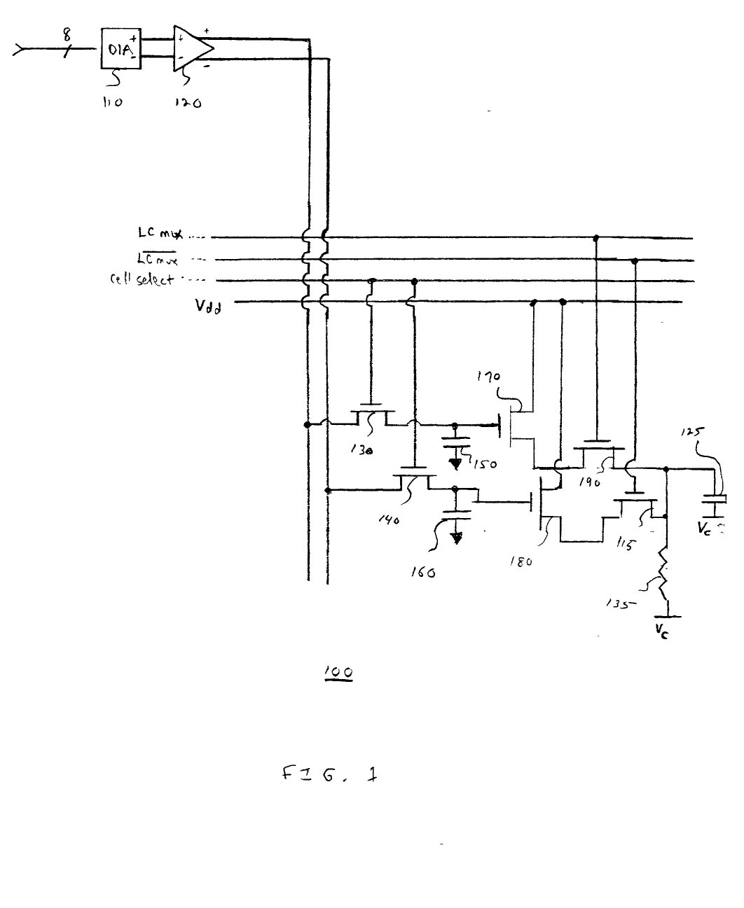

FIG. 1 is a circuit diagram illustrating an embodiment of a voltage signal storage circuit in accordance with the present invention that may be employed to apply the desired alternating voltage signal, while also providing advantages over the approach illustrated in FIG. 4. Of course, the invention is not restricted in scope to use in liquid crystal displays or with liquid crystal cells. As illustrated in FIG. 1, a DIA converter 110 and differential amplifier 120 are included. Likewise, transistors 130 and 140 and voltage signal storage elements, such as storage capacitors 150 and 160 here, are employed. In this context, the term voltage signal storage element refers to a component, subcomponent, device, or any combination thereof designed or constituted to store a voltage signal, including an analog storage device or a digital storage device. As illustrated, a digital-to-analog (DIA) converter 110 receives as an input signal, video data signals. As illustrated in this particular embodiment, eight bits are applied to DIA converter 110, although the invention is not limited in scope in this respect. Therefore, in this particular embodiment 256 distinguishable signal values may be applied to DIA converter 110 as for a gray scale image. As illustrated, DIA converter 110 produces analog voltage signals that are applied to differential amplifier 120. Differential amplifier 120 amplifies these analog voltage signals, and these amplified voltage signals are applied to transistors 130 and 140, as illustrated. Likewise, this particular cell is enabled by a cell enabler or cell select signal which is applied to the gates of transistors 130 and 140. For example, although the invention is not limited in scope in this respect, techniques used to randomly address digital memory or other similar approaches may be employed. Therefore, when a signal is applied to the gates of transistors 130 and 140, the output voltage signal of differential amplifier 220 is stored on voltage signal storage elements, such as storage capacitors 150 and 160 here. As illustrated, these respective storage capacitors in this embodiment should hold voltage signals of opposite polarity. As illustrated in FIG. 1, for embodiment 100, the voltage across capacitors 150 and 160 are therefore respectively applied to the gates of transistors 170 and 180. Therefore, in this particular embodiment, the storage capacitors are electrically isolated or insulated from direct contact with liquid crystal cell 125 by transistors 170 and 180.

Transistors 190 and 115 are coupled in a configuration to operate as a multiplexer or MUX. Therefore, in this embodiment, a square wave signal and its complement are respectively applied to the gates of transistors 190 and 115. By applying the square wave signals, in the configuration illustrated in FIG. 1, an alternating voltage is effectively applied across liquid crystal cell 125 at a substantially predetermined frequency. Typically, although not necessarily, this predetermined frequency will be related, at least in part, to the particular LC material employed. Likewise, the frequency of the square wave applied to transistors 190 and 115 need have no particular relation to when voltages are applied to capacitors 150 and 160. In this embodiment, although the invention is not limited in scope in this respect, a first voltage signal value is applied or driven onto one capacitor or voltage signal storage element, while substantially simultaneously, a second voltage signal value, comprising the logical inverse of that first voltage signal value, is applied or driven onto the other capacitor; however, this application of respective voltage signals to the respective capacitors or voltage signal storage elements occurs, in this embodiment, asynchronously and arbitrarily, such as with respect to the application of other voltage signals to other voltage signal storage elements as may be employed along with this particular embodiment in a system, such as an LCD system, for example. Of course, other embodiments in accordance with the invention other than an LCD system, such as a plurality of storage circuits, for example, might likewise employ this approach. Furthermore, in this particular embodiment, the voltage signal storage elements, or capacitors here, are sampled in a manner asynchronous with respect to the previously described application of the voltage signals to the voltage signal storage elements. In this embodiment, voltage signal modulation occurs by sampling the voltage signal value of one voltage signal storage element and then, alternatively, its logical inverse, by sampling the other voltage signal storage element. Of course, signal modulation could be achieved other ways, such as, for example, without using voltage signal logical inverses and/or by using more than two voltage signal storage elements, for example. In this particular embodiment, although, again, the invention is not limited in scope in this respect, following the asynchronous application of voltage signals or a “refresh,” an immediate change in modulation is induced due at least in part to the alternative sampling employed. This immediate change occurs in part because the voltage signal storage elements are continually sampled. Thus, the effect observed visually of applying this voltage modulation to the light modulating element, such as a LC cell, for example, is asynchronous as well. Although this feature has a number of associated advantages, one particular advantage is that it enables asynchronous update to the light modulating element of the diaplay.

As indicated, an embodiment of a voltage signal modulation circuit in accordance with the present invention may provide several possible advantages. For example, as alluded to above, a lower bandwidth may be employed, such as for a liquid crystal display that employs an embodiment of a voltage signal modulation circuit in accordance with the present invention, and yet still achieve an image having a desired number of pixels. Likewise, if a voltage signal modulation circuit in accordance with the present invention, such as the embodiment previously described, is employed, multiple image sources employing different frame rates may be combined without employing circuitry to synchronize the signals from the different sources. For example, because voltage signals are continually sampled from the storage capacitors, where multiple image sources are employed or combined, these signals may be rendered at their own individual frame rate since, to the end user, the visual changes occur asynchronously as the voltage signals are applied to the storage elements.

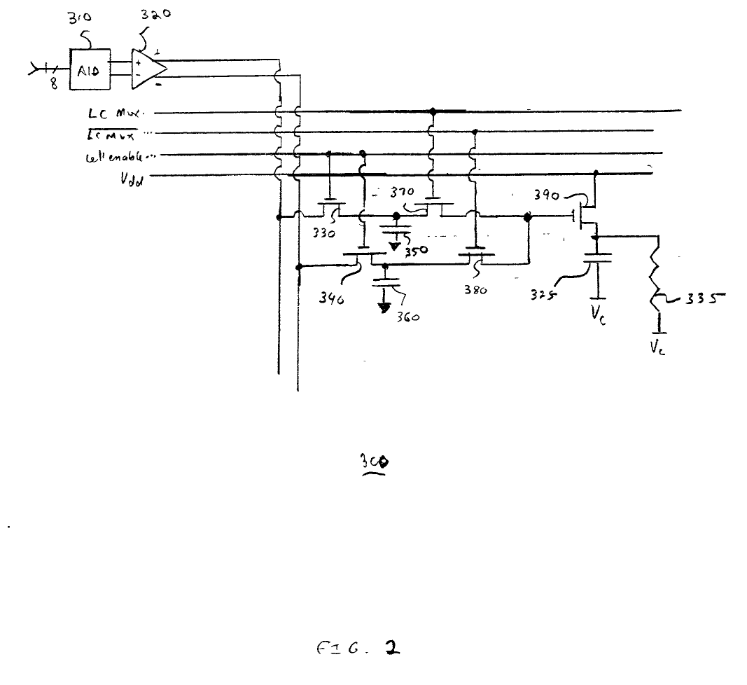

FIG. 2 is a circuit diagram illustrating another embodiment of a voltage signal modulation circuit in accordance with the present invention. As illustrated in FIG. 2, one advantage of this particular embodiment over the embodiment illustrated in FIG. 1 is the fact that whereas the embodiment illustrated in FIG. 1 employs six transistors, this particular embodiment employs five transistors. However, a disadvantage of this particular embodiment is that due to the presence of a parasitic capacitance for transistor 390, the performance of the circuit is not as good as the embodiment illustrated in FIG. 1. More specifically, the parasitic capacitance may result in a reduction of the “hold time” for the storage capacitors. A number of considerations may affect the desirability of using an embodiment such as this, where the circuit is less complex, but the hold time is reduced. For example, aspects of the silicon processing technology employed, the particular circuit design, and the particular LC material used may be among the considerations.

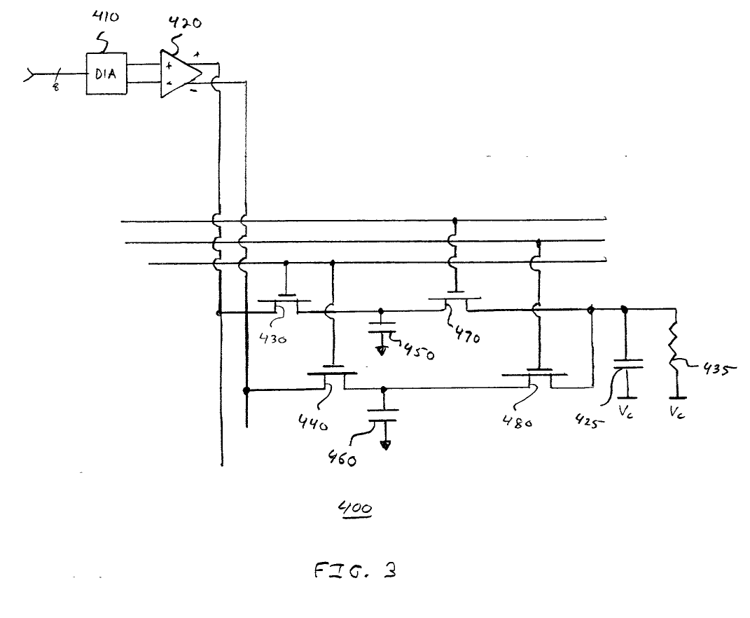

A similar observation may be made with respect to the embodiment illustrated in FIG. 3. The performance of this particular embodiment is not as good as the performance of the embodiment illustrated in FIG. 2, although one less transistor is employed. Again, design considerations may be an issue. For example, as illustrated in FIG. 3 by an idealized capacitor and resistor, the liquid crystal cell may impact the storage element hold time.

Of course, an embodiment of a voltage signal modulation circuit in accordance with the present invention is not limited to the previous embodiments. For example, a modulation circuit may include a first circuit to substantially simultaneously and asynchronously drive voltage signals onto respective voltage signal storage elements, such as capacitors, even though the voltage signals are not respectively of opposite polarity. Likewise, instead of employing dual capacitors, a plurality of capacitors, such as more than two capacitors, may be employed. Likewise, a second circuit may be employed to sample the respective voltage signal storage elements. Of course, the sampling may be performed so as to substantially maintain a substantially DC-bias, such as a substantially zero-DC bias, as previously described. For example, a positive or negative bias may be maintained by sampling the voltage signal storage elements. However, the invention is not limited in scope in this respect. An embodiment of a voltage modulation circuit in accordance with the invention may locally produce a modulated voltage signal, such as with no particular DC-bias, for example. In addition, an embodiment of a voltage signal modulation circuit in accordance with the invention may enable a display system, such as a LC display system, for example, that is randomly addressable. Although the invention is not limited in scope in this respect, currently available drive circuitry, for example, may be employed. Likewise, such an embodiment may be asynchronously updateable and may be low bandwidth, as desired. Furthermore, although the previous embodiment illustrates a reflective light valve, in alternative embodiments, light may be transmitted through the liquid crystal cell to modulate the light, as is done in back-lit flat panel LC displays. In yet another embodiment of a voltage signal modulation circuit in accordance with the invention, instead of storage capacitors, other embodiments of voltage signal storage elements may be employed. For example, a static random access memory (SRAM) or dynamic RAM (DRAM), such as an 8-bit SRAM, for example, may be employed. In such an embodiment, however, a differential amplifier, such as 120 in FIG. 1, for example, may be omitted. However, a digital-to-analog converter may be employed to convert the 8-bit binary digital signal to an analog voltage to be sampled.

In addition, embodiments of a voltage signal modulation circuit, such as the embodiments previously described, may implement an embodiment of a method of modulating a voltage signal locally in accordance with the present invention. For example, as previously described, respective voltage signals, such as positive and negative voltage signals, may be applied to respective voltage signal storage elements, such as storage capacitors, substantially simultaneously and asynchronously. Likewise, the voltage signals of the respective voltage signal elements may be sampled so as to locally produce a modulated voltage signal. Likewise, the sampling may be alternatively at a substantially predetermined rate, so as, for example, to maintain a substantially zero bias, although again the invention is not limited in scope in this respect. Likewise, a liquid crystal cell may be coupled to the voltage signal storage elements as previously described. In such an embodiment, although the invention is not limited in scope in this respect, a substantially predetermined rate may be related, at least in part, to the particular liquid crystal cell material of the liquid crystal cell. Furthermore, in another embodiment, respective voltage signals may be applied to respective voltage signal elements substantially simultaneously and asynchronously, although the voltage signals may not comprise respective voltage signals of opposite polarity. Likewise, the voltage signals may be applied to a plurality of voltage signal storage elements, such as more than two voltage signal storage elements. Furthermore, the voltage signals of the respective storage elements may be sampled, as previously indicated, to locally produce a modulated voltage signal or to substantially maintain a substantially DC-bias other than a substantially zero-DC bias.

While certain features of the invention have been illustrated and described herein, many modifications, substitutions, changes and equivalents will now occur to those skilled in the art. It is, therefore, to be understood that the appended claims are intended to cover all such modifications and changes as fall within the true spirit of the invention.

1. A circuit for modulating voltage signals comprising:
a first circuit configuration to substantially simultaneously and asynchronously drive respective positive and negative voltage signals onto respective voltage signal storage elements;
and a second circuit configuration to alternatively sample the respective voltage signals of the respective voltage signal storage elements at a substantially predetermined rate.

2. The circuit of claim 1, and further comprising a liquid crystal cell coupled to said second circuit configuration.

3. The circuit of claim 2, wherein the substantially predetermined rate is related, at least in part, to the particular liquid crystal material of the liquid crystal cell.

4. The circuit of claim 2, wherein said first circuit configuration includes circuitry to address said liquid crystal cell.

5. The circuit of claim 4, wherein said circuit for modulating voltage signals is coupled in a liquid crystal display (LCD) system;
said LCD system being adapted to substantially simultaneously and asynchronously drive additional voltage signals onto respective voltage signal storage elements so that the stored voltage signals of the respective voltage signal storage elements are refreshed.

6. The circuit of claim 2, wherein said second circuit comprises a plurality of transistors coupled to electrically isolate said voltage signal storage elements from said liquid crystal cell while alternatively sampling the respective voltage signals of the respective voltage signal storage elements.

7. The circuit of claim 1, wherein the voltage signal storage elements comprise capacitors.

8. The circuit of claim 1, wherein said circuit for modulating voltage signals is embodied on an integrated circuit chip.

9. A liquid crystal display (LCD) system comprising:
a voltage signal modulation circuit to locally modulate the voltage signal applied across a liquid crystal cell in said LCD system;
said voltage signal modulation circuit including a first circuit configuration to substantially simultaneously and asynchronously drive respective positive and negative voltage signals onto respective voltage signal storage elements and a second circuit configuration to alternatively sample the respective voltage signals of the respective voltage signal storage elements at a substantially predetermined rate.

10. The LCD system of claim 9, and further comprising at least one liquid crystal cell coupled to said voltage signal modulation circuit.

11. The LCD system of claim 10, wherein the substantially predetermined rate is related, at least in part, to the particular liquid crystal material of the liquid crystal cell.

12. The LCD system of claim 10, wherein said system includes circuitry to address said at least one liquid crystal cell.

13. The LCD system of claim 10, wherein said LCD system is adapted to substantially simultaneously and asynchronously drive additional voltage signals onto the respective voltage signal storage elements so as to refresh the stored voltage signals.

14. A method of modulating a voltage signal locally comprising:
applying respective positive and negative voltage signals to respective voltage signal storage elements substantially simultaneously and asynchronously; and
sampling the voltage signals of the respective voltage storage elements alternatively at a substantially predetermined rate.

15. The method of claim 14, and further comprising a liquid crystal cell coupled to the voltage signal storage elements.

16. The method of claim 15, wherein the substantially predetermined rate is related, at least in part, to the particular liquid crystal cell material of the liquid crystal cell.

17. The method of claim 14, wherein the voltage signal storage elements comprise capacitors.

18. A voltage signal modulation circuit comprising:
a first circuit to substantially simultaneously and asynchronously drive respective voltage signals onto respective voltage signal storage elements; and
a second circuit to sample the voltage signals of the respective voltage signal storage elements so as to locally produce a modulated voltage signal.

19. The voltage signal modulation circuit of claim 18, wherein the voltage signals comprise respective positive and negative voltage signals and the respective voltage signal storage elements comprise two respective voltage signal storage elements;
said first circuit being adapted to substantially simultaneously and asynchronously drive the respective positive and negative voltage signals onto the two respective voltage signal storage elements.

20. The voltage signal modulation circuit of claim 18, wherein said second circuit is adapted to sample the voltage signals of the respective voltage signal storage elements at a substantially predetermined rate.

21. The circuit of claim 1 8, wherein said second circuit is further adapted to sample the voltage signals of the respective voltage signal storage elements so as to substantially maintain a substantially DC bias.

22. A method of modulating a voltage signal locally comprising:
applying respective voltage signals to respective voltage signal storage elements substantially simultaneously and asynchronously; and
sampling the voltage signals of the respective voltage signal storage elements at a substantially predetermined rate so as to locally produce the modulated voltage signal.

23. The method of claim 22, wherein the voltage signals of the respective voltage signal storage elements are sampled so as to substantially maintain a substantially DC bias.

24. A display system comprising:
a voltage signal modulation circuit to locally modulate the voltage signal applied across a light modulating element in said display system;
said voltage signal modulation circuit including a first circuit configuration to substantially simultaneously and asynchronously drive respective voltage signals onto respective voltage signal storage elements and a second circuit configuration to sample the voltage signals of the respective voltage signal storage elements at a substantially predetermined rate so as to locally produce a modulated voltage signal.

25. The system of claim 25, wherein said system is adapted to drive substantially simultaneously and asynchronously additional voltage signals onto the respective voltage signal storage elements so as to refresh the stored voltage signals.
